(19) United States
(12) Patent Application Publication
(10) Pub. No.: US 2005/0158507 A1
(43) Pub. Date: Jul. 21, 2005

(54) Device for catching falling leaves from a tree and associated methods

(76) Inventor: Riley H. Nelson, Orlando, FL (US)

Correspondence Address: MICHAEL W. TAYLOR, ESQUIRE;ALLEN, DYER, DOPPELT, MILBRATH & GILCHRIST, P.A., P.O. Box 3791, Orlando, FL, 32802-3791, US

(21) Appl. No.: 11/037,503

(22) Filed: Jan. 18, 2005

Related U.S. Application Data
(60) Provisional application No. 60/536,643, filed on Jan. 15, 2004.

(51) Int. Cl. B32B 3/02

(52) U.S. Cl. 428/66.6

(57) ABSTRACT

A leaf catching device includes a flexible net having a medial opening and is movable between folded and deployed positions. The flexible net when in the deployed position extends outwardly from a tree trunk passing through the medial opening for catching falling leaves. An inner support ring is coupled to the flexible net adjacent the medial opening, and an outer support ring is coupled to the flexible net adjacent an outer edge thereof. Ground supports are coupled to the inner and outer support rings for elevating the flexible net above ground when in the deployed position.

### RELATED APPLICATION

This application claims the benefit of U.S. Provisional Application Ser. No. 60/536,643 filed Jan. 15, 2004, the entire contents of which are incorporated herein by reference.

### FIELD OF THE INVENTION

The present invention relates to the field of leaf catching and collecting devices, and more particularly, to a device for catching leaves falling from a tree.

### BACKGROUND OF THE INVENTION

For deciduous trees, collecting and discarding leaves during the fall is very common in residential and commercial communities. If the wind is blowing when leaves are falling, they generally become scattered across the landscape, which may pose a collection problem.

One approach for this problem is disclosed in U.S. Pat. No. 4,366,949 directed to a leaf catching and collecting device. The device comprises post members partially driven into the ground, and a flexible netting is hooked to the post members extending above the ground. The flexible netting is laid over the ground and is held in place by hooks driven into the ground. The device is positioned so that it faces the source of the leaves, and collects the leaves as they are blown across the landscape. After the leaves collect on the flexible netting, the netting is unhooked and the leaves are discarded.

If there is little or no wind when leaves are falling, they generally fall and accumulate on the grass under the tree. To collect the leaves, they are generally raked. Depending on the amount of leaves, this may be a significant amount of work. If the leaves remain on the grass for an extended period of time before they are raked, the leaves may choke or smother the grass by not allowing an adequate amount of sunlight and air to reach the underlying grass. Moreover, the leaves may cause fungus and molds to develop, which may be harmful to the underlying grass.

### SUMMARY OF THE INVENTION

In view of the foregoing background, it is therefore an object of the present invention to provide a device for catching and collecting leaves as they fall from a tree before they hit the ground.

This and other objects, features, and advantages in accordance with the present invention are provided by a leaf catching device comprising a flexible net having a medial opening and movable between folded and deployed positions. The flexible net when in the deployed position extends outwardly from a tree trunk passing through the medial opening for catching falling leaves.

An inner support ring may be coupled to the flexible net adjacent the medial opening, and may comprise a plurality of rigid inner sections and a plurality of separable inner joints between adjacent rigid inner sections to facilitate movement to the folded position. An outer support ring may be coupled to the flexible net adjacent an outer edge thereof, and may comprise a plurality of rigid outer sections and a plurality of separable outer joints between adjacent rigid outer sections to facilitate movement to the folded position.

A plurality of ground supports may be coupled to the inner and outer support rings for elevating the flexible net above ground when in the deployed position. The falling leaves do not collect on the ground under the tree since the flexible net is elevated above ground. This allows an adequate amount of sunlight and air to reach the underlying grass. Otherwise, if the leaves were to remain on the ground for an extended period of time, the grass may become choked or smothered.

In addition, the folded position of the flexible net advantageously allows the leaf collecting device to be easily carried and stored. In addition, since the rigid sections and the separable joints for the respective inner and outer support rings can be separated from one another, this also advantageously allows the inner and outer support rings to be easily carried and stored with the flexible net.

The leaf catching device may further comprise at least one intermediate support ring coupled to the flexible net between the inner and outer support rings. Each intermediate support ring may comprise a plurality of rigid intermediate sections and a plurality of separable intermediate joints between adjacent rigid intermediate sections to facilitate movement to the folded position. The leaf catching device may further comprise at least one radial support member coupled between the inner and outer support rings.

The plurality of ground supports may be adjustable in length. In one embodiment, each ground support may comprise a lower member to be placed in the ground and flush therewith, and an upper member coupled to the lower member. The upper member may also be adjustable in length. The lower member may have a medial opening for receiving the upper member, and the leaf catching device may further comprise a plurality of plugs. Each plug is for inserting into the medial opening of a respective lower member when the upper member is not coupled thereto.

The ground supports may position the inner support ring below the outer support ring so that the collected leaves are not easily blown away. The flexible net may comprise at least one trap door panel. A container may be placed under each trap door panel to receive the collected leaves. The flexible net has a seam therein to permit positioning around the tree trunk.

Another aspect of the invention is directed to using a leaf catching device as described above for catching leaves falling from a tree. The method may comprise coupling the plurality of separable inner joints between the plurality of adjacent rigid inner sections to form the inner support ring. A plurality of separable outer joints may be coupled between a plurality of adjacent rigid outer sections to form the outer support ring. The plurality of ground supports may be coupled to the inner and outer support rings for elevating the inner and outer support rings above ground. The flexible net may then be deployed around a tree trunk of the tree, with the flexible net extending outwardly from the tree trunk passing through the medial opening thereof. The flexible net may be coupled to the inner and outer support rings so that the flexible net is elevated above ground when in the deployed position.

### BRIEF DESCRIPTION OF THE DRAWINGS

FIG. 1 is a perspective view of a leaf catching device under a tree in accordance with the invention.

FIG. 2 is a top view of the leaf catching device illustrated in FIG. 1 with the tree removed.

FIG. 3 is a perspective view of the leaf catching device illustrated in FIG. 1 with both the flexible net and tree removed.

FIG. 4 is an enlarged sectional view of a portion of the leaf catching device illustrated in FIG. 2.

FIG. 5 is a perspective view of one embodiment of the lower and upper members forming the ground supports for the flexible net in accordance with the invention.

FIG. 6 is a perspective view of another embodiment of the upper member illustrated in FIG. 5.

FIG. 7 is a perspective view of the leaf catching device in a concave position under a tree in accordance with the invention.

FIG. 8 is a perspective view of a rake used for clearing leaves from the flexible net in accordance with the invention.

FIG. 9 is a perspective view of a container grabber for placing/retrieving a container under a trap door panel in the flexible net in accordance with the invention.

FIG. 10 is a flow chart for using a leaf catching device for catching leaves falling from a tree in accordance with the invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

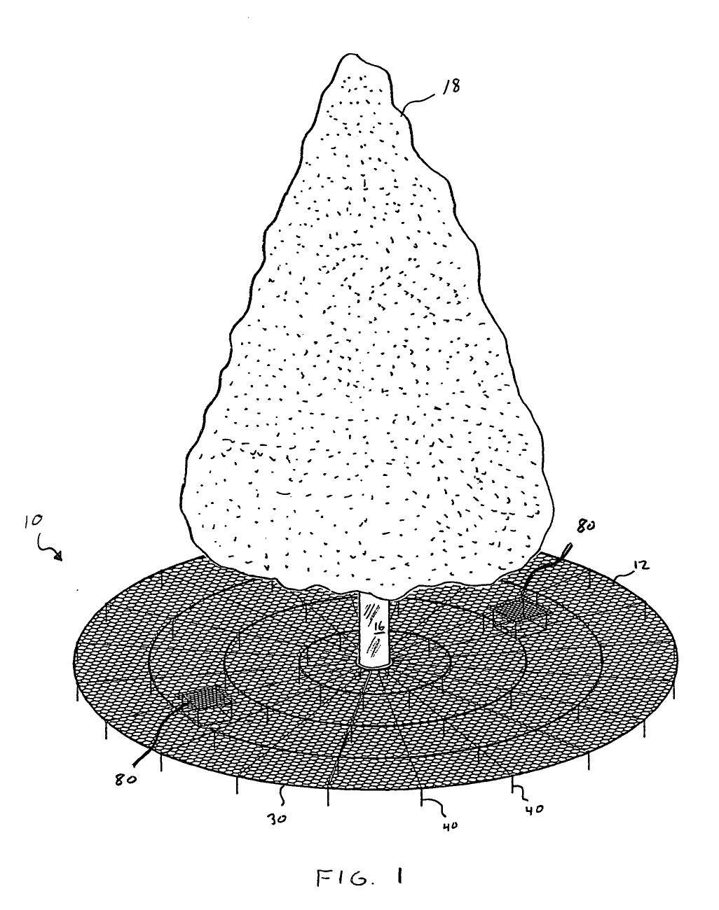

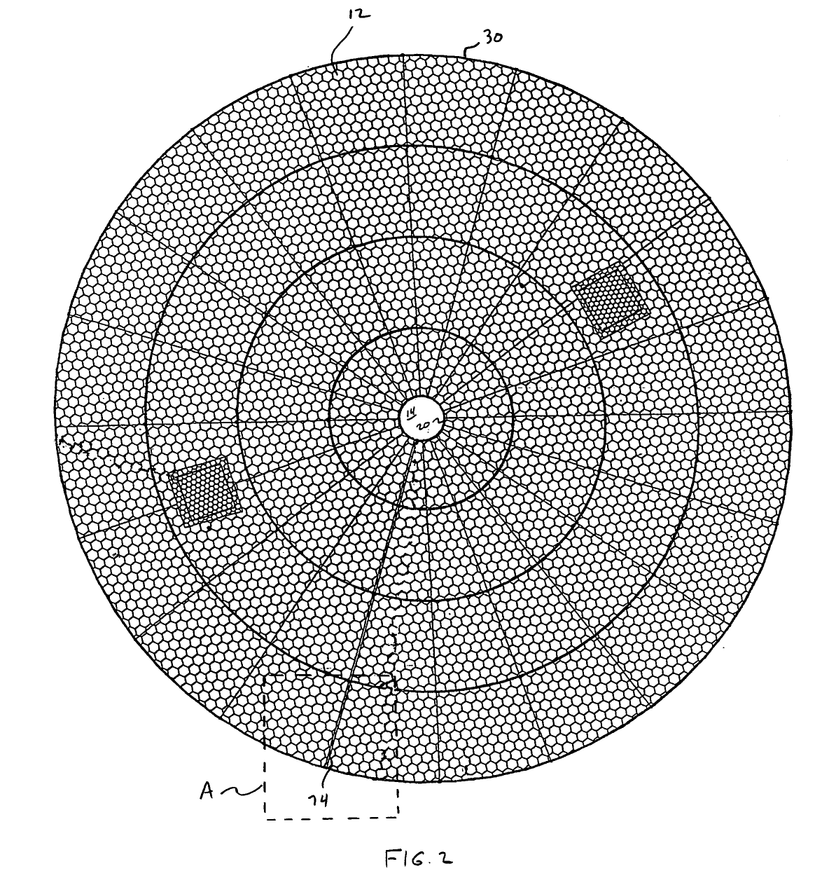

Referring initially to FIGS. 1-4, a leaf catching device 10 in accordance with the invention will now be discussed. The leaf catching device 10 comprises a flexible net 12 having a medial opening 14 and is movable between folded and deployed positions. When the flexible net 12 is in the deployed position, it extends outwardly from a tree trunk 16 passing through the medial opening 14 for catching falling leaves from the tree 18. Even though the flexible net 12 is illustrated as having a circular shape, other shapes may be used.

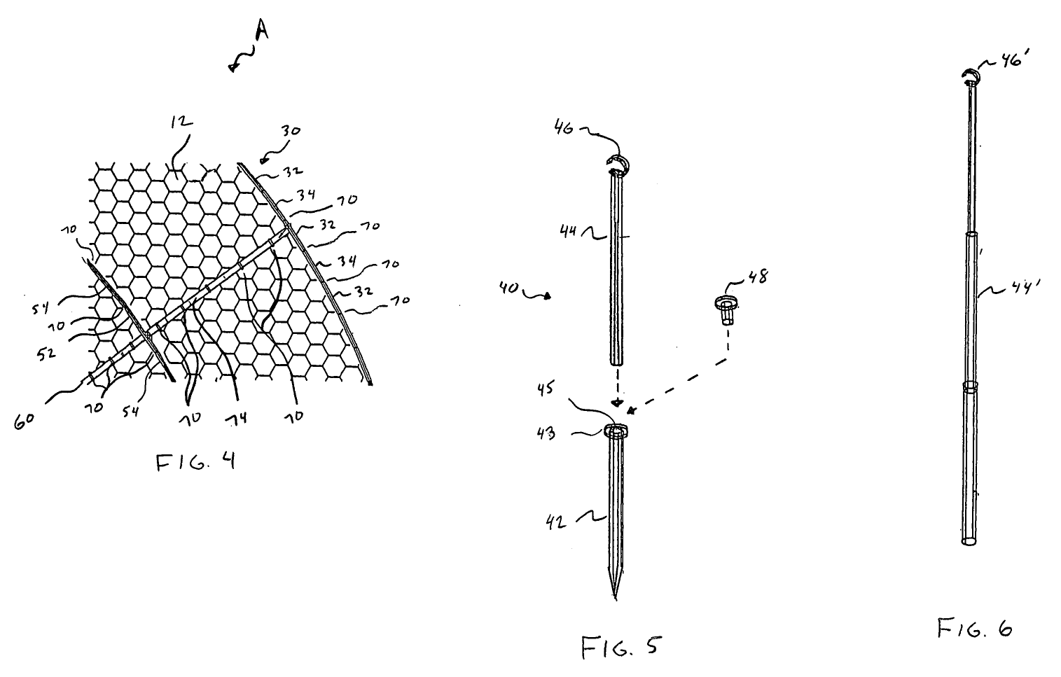

An inner support ring 20 is coupled to the flexible net 12 adjacent the medial opening 14, and an outer support ring 30 is coupled to the flexible net adjacent an outer edge thereof. The inner support ring 20 comprises a plurality of rigid inner sections and a plurality of separable inner joints between adjacent rigid inner sections to facilitate movement to the folded position. Likewise, the outer support ring 30 comprises a plurality of rigid outer sections 32 and a plurality of separable outer joints 34 between adjacent rigid outer sections to facilitate movement to the folded position, as best illustrated in FIG. 4.

In one embodiment, the rigid sections for the respective inner and outer support rings 20, 30 are configured with male ends, whereas the separable joints for the respective inner and outer support rings are configured with female ends, as readily appreciated by those skilled in the art. The rigid sections and the separable joints may also be configured much like a tent pole that is also linked together by a cord so that they are remain together even when they are not coupled together. Of course, other configurations for coupling together the rigid sections and the separable joints are acceptable, as readily appreciated by those skilled in the art.

A plurality of ground supports 40 are coupled to the inner and outer support rings 20, 30 for elevating the flexible net 12 above ground when in the deployed position. The falling leaves do not collect on the ground under the tree 18 since the flexible net 12 is elevated above ground. This allows an adequate amount of sunlight and air to reach the underlying grass. Otherwise, if the leaves were to remain on the ground for an extended period of time, the grass may become choked or smothered due to a lack of sunlight and air.

As noted above, the flexible net 12 may be movable between a folded position and a deployed position. Since the leaf collecting device 10 is primarily used during the fall season, it is stored when not in use. The folded position of the flexible net 12 advantageously allows the leaf collecting device 10 to be easily carried and stored. In addition, since the rigid sections and the separable joints for the respective inner and outer support rings 20, 30 can be separated from one another, this also advantageously allows the inner and outer support rings 20, 30 to be easily carried and stored with the flexible net 12.

The leaf collecting device 10 may be built in a variety of predetermined sizes to accommodate different size trees. For example, the diameter of the leaf collecting device 10 may vary from four or five feet for relatively small trees, and up to forty to fifty feet for relatively large trees. Of course, these numbers are for illustrative purposes only and the actual size of the leaf collecting device 10 can vary depending on the size of the tree 18. In addition, the medial opening 14 of the flexible net 12 may be adjustable to accommodate more than one size tree trunk. Otherwise, each flexible net 12 is formed with a predetermined medial opening 14 based upon the diameter of the net. That is, larger size diameter nets would have a larger medial opening 14.

The leaf catching device 10 may further comprise one or more intermediate support rings 50 coupled to the flexible net 12 between the inner and outer support rings 20 and 30. The number of intermediate supports rings 50 depends on the size of the flexible net 12. For smaller size flexible nets, the inner and outer support rings 20, 30 may be sufficient for supporting the flexible net 12. When intermediate supports rings 50 are used, ground supports 40 may also be connected thereto for elevating the flexible net 12 above ground when in the deployed position.

Each intermediate support ring 50 comprises a plurality of rigid intermediate sections 52 and a plurality of separable intermediate joints 54 between adjacent rigid intermediate sections to facilitate movement to the folded position. The leaf catching device 10 also comprises a plurality of spaced apart radial support members 60 coupled between the inner and outer support rings 20 and 30, as well as to the intermediate support rings 50. The radial support members 60 also provide support for the flexible net 12.

As with the inner, intermediate and outer support rings 20, 50 and 30, the radial support members 60 may also comprise a plurality of rigid radial support sections and a plurality of separable radial support joints between adjacent rigid radial support sections. The discussion above pertaining to the different embodiments of the rigid sections and the separable joints for the respective inner and outer support rings 20, 30 is also applicable for the intermediate support rings 50 and the radial support members 60.

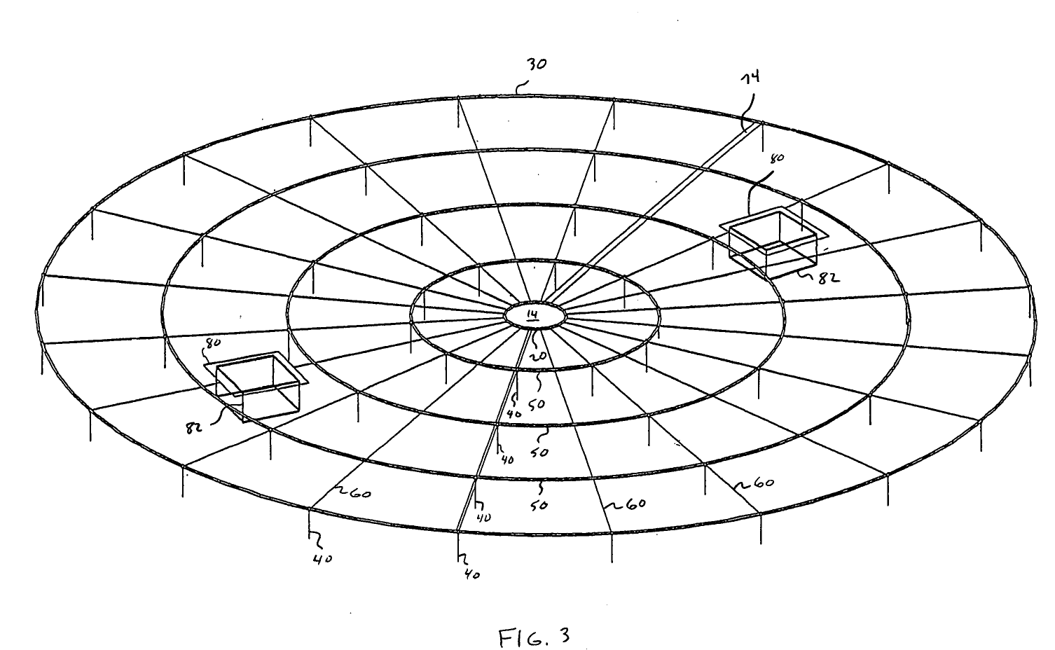

Referring now to FIG. 3, the ground supports 40 are inserted into the ground, and the inner, intermediate and outer support rings 20, 50 and 30 are coupled thereto. The radial support members 60 are also coupled between the inner and outer support rings 20, 30 and to the intermediate support members 50. Next, the flexible net 12 is deployed around the tree trunk 16. The flexible net 12 may be one piece, or it may be in multiple sections. The flexible net 12 is coupled to the inner, intermediate and outer support rings 20, 50 and 30 via hooks 70, for example. Attachment of the flexible net 12 is not limited to hooks 70. Other means for attaching the flexible net 12 to the inner, intermediate and outer support rings 20, 50 and 30 are readily acceptable, as readily appreciated by those skilled in the art.

The flexible net 12 has at least one seam 74 therein to permit positioning around the tree trunk 16. A radial support member 60 is adjacent the seam 74 so that hooks 70 may also be used for closing the seam, as best illustrated in FIG. 4.

The flexible net 12 may comprise a mesh type net as readily appreciated by those skilled in the art. In one embodiment, the mesh net is plastic coated and is painted with a neutral color for blending in with the landscape.

In one embodiment the ground supports 40 are all the same length so that the flexible net 12 is in a horizontal position, as illustrated in FIGS. 1 and 3. In the horizontal position, the flexible net 12 is about one to two feet above the ground, for example.

Each ground support 40 may comprise a lower member 42 to be placed in the ground and flush therewith, and an upper member 44 connected to the lower member, as illustrated in FIG. 5. The lower member 42 may be cylindrically shaped, and about 18 to 24 inches in length. The lower member 42 is driven into the ground for providing stability for the upper member 44. The lower member 42 has a flared upper edge 43 for acting as a stop with the ground, and has a medial opening 45 for receiving the upper member 44. The illustrated upper member 44 has a fixed height, such as between one and two feet, for example. Each upper member includes a hooked end 46 for coupling to the inner, intermediate and outer support rings 20, 50 and 30. Instead of hooked ends 46, other means for coupling the upper members 44 to the various support rings 20, 50, 30 are acceptable, as readily appreciated by those skilled in the art.

When the leaf collecting device 10 is no longer necessary, that is, the leaves are no longer falling from the tree 18, the flexible net 12 is unhooked from the inner, intermediate and outer support rings 20, 50, 30. The flexible net 12 is then placed in the folded position. For the inner, intermediate and outer support rings 20, 50, 30, their respective rigid sections and separable joints are separated.

The upper members 44 are then removed from the respective lower members 42. The lower members 42 may be removed from the ground, or they may be left therein for use next year. If this is the case, then a respective plug 48 is inserted into the medial opening 45 in each corresponding lower member 42. This prevents water, dirt and debris from entering and clogging the medial opening 45 so that the upper member 44 can be later inserted therein without any difficulty.

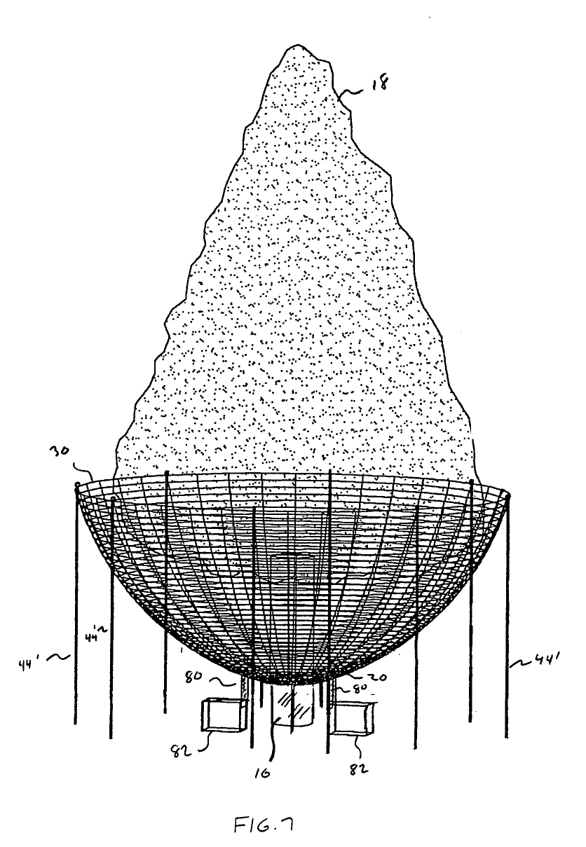

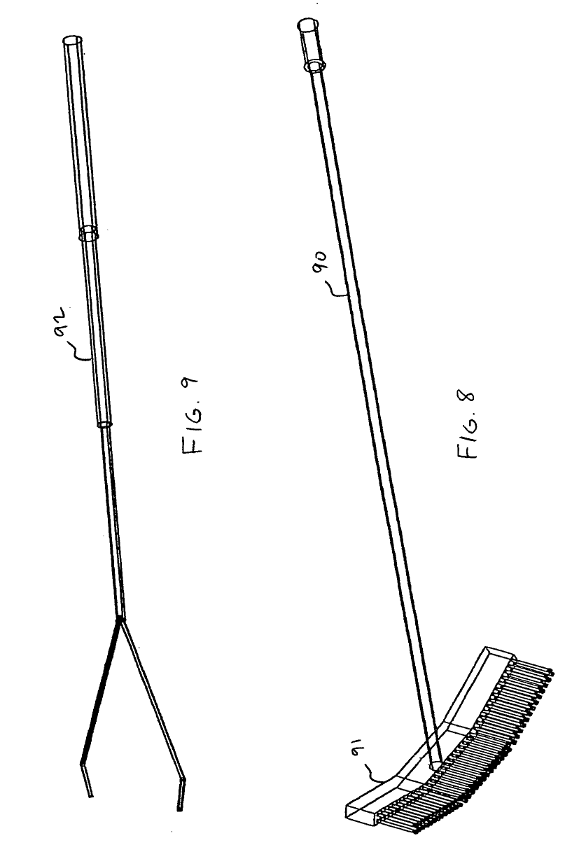

In another embodiment, the upper member 44′ is adjustable in length, as illustrated in FIG. 6. The upper member 44′ has a telescoping configuration for selecting a desired length. This allows the ground supports to be of different lengths so that they position the inner support ring 20 below the outer support ring 30. This advantageously provides an inwardly sloped or concave shape to the flexible net 12 so that the leaves do not easily blow out after being collected, as illustrated in FIG. 7. The telescoping upper members 44′ may extend in length from four to six feet, for example, to provide a distinctive concave shape to the flexible net 12 for collecting the leaves from the tree 18. In other embodiments, the telescoping upper members 44′ may even extend the full height of the tree.

After the leaves have been collected by the flexible net 12, they may be removed through trap door panels 80 in the flexible net. As best illustrated in FIG. 7, the trap door panels 80 are unhinged so that they drop down to the ground. A container 82 is placed under each trap door panel 80 to receive the collected leaves. The illustrated containers 82 have a rectangular shape. However, they may also have other shapes, such as a circular shape, for example. Likewise, the illustrated trap door panels 80 have a rectangular shape, but they may also have other shapes, such as a circular shape, for example.

A rake 90 as illustrated in FIG. 8 may be used to reach across the flexible net 12 for directing the leaves into the respective containers 82 through the corresponding trap door panels 80. The rake 90 is preferably a plastic coated leaf rake to prevent damaging the flexible net 12. The rake 90 has an angled head 91 to help pull the leaves across the flexible net 12 toward the trap door panels 80.

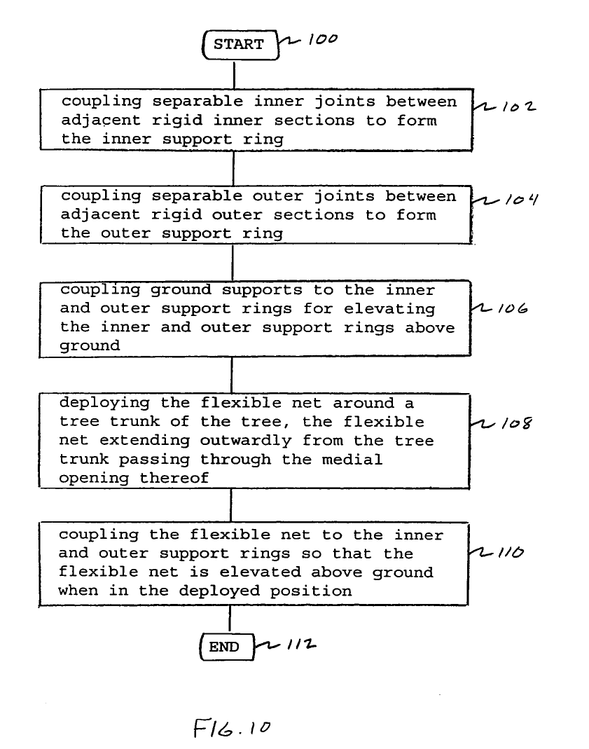

For placing/retrieving the containers 82 under the trap door panels 80, a container grabber 92 may be used, as illustrated in FIG. 9. The illustrated container grabber 92 is telescoping to accommodate the different size flexible nets that may be used. The container grabber 92 is also used to open and close the trap door panels 80.

Another aspect of the invention is directed to a method for using a leaf catching device 10 for catching leaves falling from a tree 18. The leaf catching device comprises a flexible net 12 having a medial opening 14 and is movable between folded and deployed positions. An inner support ring 20 is adjacent the medial opening 14, and an outer support ring is adjacent an outer edge of the flexible net 12. The leaf catching device further comprises a plurality of ground supports 40.

From the start (Block 100), the method comprises coupling a plurality of separable inner joints between a plurality of adjacent rigid inner sections to form the inner support ring 20 at Block 102. A plurality of separable outer joints are coupled between a plurality of adjacent rigid outer sections to form the outer support ring 30 at Block 104. The plurality of ground supports 40 are coupled to the inner and outer support rings 20, 30 for elevating the inner and outer support rings above ground at Block 106. The flexible net 12 is deployed around a tree trunk 16 of the tree 18, with the flexible net extending outwardly from the tree trunk passing through the medial opening 14 thereof at Block 108. The flexible net 12 is coupled to the inner and outer support rings 20, 30 so that the flexible net is elevated above ground when in the deployed position at Block 110. The method ends at Block 112.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A leaf catching device comprising:
a flexible net having a medial opening and movable between folded and deployed positions, said flexible net when in the deployed position extending outwardly from a tree trunk passing through the medial opening for catching falling leaves;
an inner support ring coupled to said flexible net adjacent the medial opening, and comprising a plurality of rigid inner sections and a plurality of separable inner joints between adjacent rigid inner sections to facilitate movement to the folded position;
an outer support ring coupled to said flexible net adjacent an outer edge thereof, and comprising a plurality of rigid outer sections and a plurality of separable outer joints between adjacent rigid outer sections to facilitate movement to the folded position; and
a plurality of ground supports coupled to said inner and outer support rings for elevating said flexible net above ground when in the deployed position.

2. A leaf catching device according to claim 1 further comprising at least one intermediate support ring coupled to said flexible net between said inner and outer support rings, and comprising a plurality of rigid intermediate sections and a plurality of separable intermediate joints between adjacent rigid intermediate sections to facilitate movement to the folded position.

3. A leaf catching device according to claim 1 further comprising at least one radial support member coupled between said inner and outer support rings.

4. A leaf catching device according to claim 1 wherein said plurality of ground supports are adjustable in length.

5. A leaf catching device according to claim 1 wherein each ground support comprises:
a lower member to be placed in the ground and flush therewith; and
an upper member coupled to said lower member.

6. A leaf catching device according to claim 5 wherein said upper member is adjustable in length.

7. A leaf catching device according to claim 5 wherein said lower member has a medial opening for receiving said upper member; the leaf catching device further comprising a plurality of plugs, each plug for inserting into the medial opening of a respective lower member when said upper member is not coupled thereto.

8. A leaf catching device according to claim 1 wherein said ground supports position said inner support ring below said outer support ring.

9. A leaf catching device according to claim 1 wherein said flexible net comprises at least one trap door panel.

10. A leaf catching device according to claim 9 further comprising at least one container to be placed under said at least one trap door panel.

11. A leaf caching device according to claim 1 wherein said flexible net has a seam therein to permit positioning around the tree trunk.

12. A method for using a leaf catching device for catching leaves falling from a tree, the leaf catching device comprising a flexible net having a medial opening and movable between folded and deployed positions; an inner support ring adjacent the medial opening; an outer support ring adjacent an outer edge of the flexible net; and a plurality of ground supports, the method comprising:
coupling a plurality of separable inner joints between a plurality of adjacent rigid inner sections to form the inner support ring;
coupling a plurality of separable outer joints between a plurality of adjacent rigid outer sections to form the outer support ring;
coupling the plurality of ground supports to the inner and outer support rings for elevating the inner and outer support rings above ground;
deploying the flexible net around a tree trunk of the tree, the flexible net extending outwardly from the tree trunk passing through the medial opening thereof; and
coupling the flexible net to the inner and outer support rings so that the flexible net is elevated above ground when in the deployed position.

13. A method according to claim 12 wherein the leaf catching device further comprises at least one intermediate support ring coupled to the flexible net between the inner and outer support rings, the at least one intermediate support ring comprising a plurality of rigid intermediate sections and separable intermediate joints between adjacent rigid intermediate sections; the method further comprising:
coupling the plurality of separable intermediate joints between the adjacent rigid intermediate sections to form the intermediate support ring; and
coupling the flexible net to the intermediate support ring.

14. A method according to claim 12 further comprising connecting at least one radial support member between the inner and outer support rings.

15. A method according to claim 12 further comprising adjusting a length of each ground support.

16. A method according to claim 12 wherein each ground support comprises a lower member and an upper member, the method further comprising:
placing the lower member in the ground so that the lower member is flush therewith; and
coupling the upper member to the lower member.

17. A method according to claim 16 further comprising adjusting a length of each upper member.

18. A method according to claim 16 wherein the leaf catching device further comprises a plurality of plugs; and wherein the lower member has a medial opening for receiving the upper member when coupled thereto, and when the upper member is not coupled thereto, then further comprising inserting each plug into the medial opening of a respective lower member.

19. A method according to claim 12 wherein the ground supports position the inner support ring below the outer support ring.

20. A method according to claim 12 wherein the flexible net comprises at least one trap door panel.

21. A method according to claim 20 further comprising placing at least one container under the at least one trap door panel.

22. A method according to claim 12 wherein the flexible net has a seam therein to permit positioning around the tree trunk.
